(19) United States
(12) Patent Application Publication
(10) Pub. No.: US 2013/0105264 A1
(43) Pub. Date: May 2, 2013

(54) PANTOGRAPH ASSEMBLY

(71) Applicants: Eric J. Ruth, Peoria, IL (US); Vamsi K. Doddakula, Dunlap, IL (US)

(72) Inventors: Eric J. Ruth, Peoria, IL (US); Vamsi K. Doddakula, Dunlap, IL (US)

(73) Assignee: Caterpillar Inc., Peoria, IL (US)

(21) Appl. No.: 13/281,485

(22) Filed: Oct. 26, 2011

(51) Int. Cl. B60L 5/00

(52) U.S. Cl. 191/59.1

(57) ABSTRACT

A pantograph assembly configured to transfer electrical power from an overhead conductor to a machine. The pantograph assembly includes a pantograph support detachably connected to the machine, an articulated assembly having a first end connected to the pantograph support, and a collector rail supported by a second end of the articulated assembly along a longitudinal axis. The pantograph assembly further includes an end horn connected to the collector rail. The end horn is configured to be tilted with respect to the longitudinal axis of the collector rail.

### TECHNICAL FIELD

The present disclosure relates to trolley-assist vehicles, and more particularly to a pantograph assembly for a trolley-assist vehicle.

### BACKGROUND

Machines such as trolley-assist vehicles or electric locomotives generally employ a pantograph assembly to provide electric power to the machine. Typically, the pantograph assembly is carried on top of the machine. The pantograph assembly is configured to draw power from an overhead conductor and transfer it to the machine. On machines such as off highway trucks the pantograph is raised and lowered to make connection with the overhead conductors. Specifically, the off highway trucks have significant lateral movement as compared to a locomotive, thus the pantograph assembly has an increased possibility to become entangled with the overhead conductors.

For example, Great Britain Patent Number 791,948 (the '948 patent) discloses a current-collecting pantograph for electric locomotives and vehicles. The pantograph includes a transverse current collector supporting member at the apex of the pantograph. The supporting member is capable of movement in a plane vertical to the track independently of the pantograph. However, the '948 patent does not address situations where the pantograph becomes entangled in the overhead conductors.

### SUMMARY

In one aspect, the present disclosure provides a pantograph assembly configured to transfer electrical power from an overhead conductor to a machine. The pantograph assembly includes a pantograph support detachably connected to the machine, an articulated assembly having a first end connected to the pantograph support, and a collector rail supported by a second end of the articulated assembly along a longitudinal axis. The pantograph assembly further includes an end horn connected to the collector rail. The end horn is configured to be tilted with respect to the longitudinal axis of the collector rail.

Other features and aspects of this disclosure will be apparent from the following description and the accompanying drawings.

### BRIEF DESCRIPTION OF THE DRAWINGS

FIG. 1 is side view of a pantograph assembly, according to an aspect of the present disclosure;

FIG. 2 is an isometric view of a pantograph assembly, according to an aspect of the present disclosure; and,

FIG. 3 is an isometric partial view of a portion of the pantograph assembly of FIG. 2.

### DETAILED DESCRIPTION

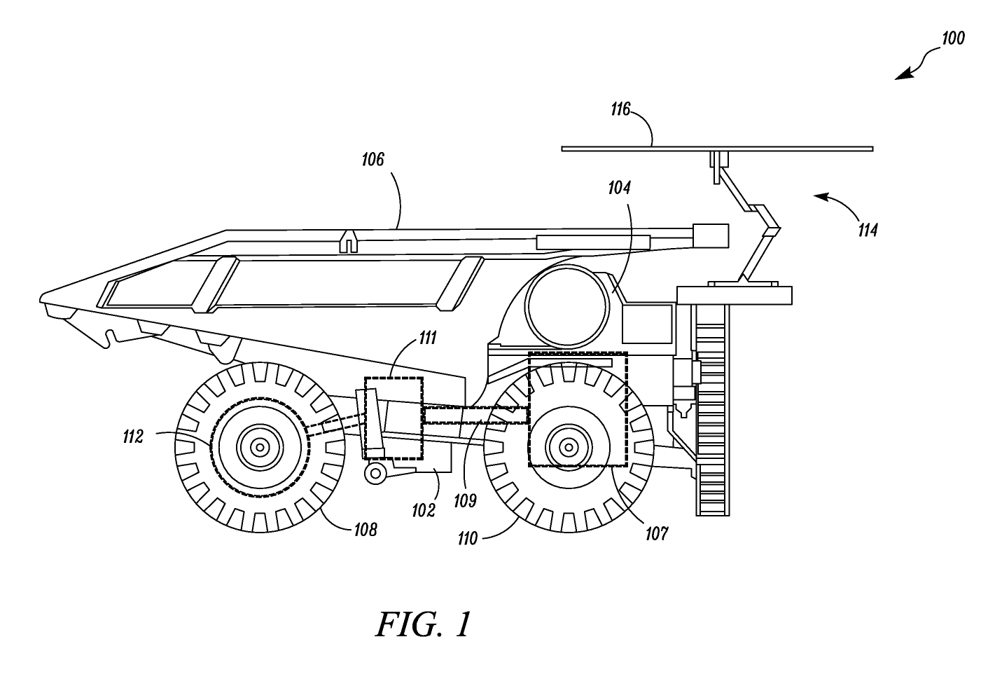

FIG. 1 illustrates a side view of a machine 100, according to an aspect of the present disclosure. The machine 100 may include a vehicle such as an off-highway truck, or other vehicle used in mining, construction, quarrying, and other applications. One example of the machine 100 is the off-highway truck including a chassis 102 that supports an operator cab 104 and a bucket 106. The bucket 106 may be pivotally connected to the chassis 102 and arranged to carry a payload when the machine 100 is in use. The machine 100 may include a power source 107, for example, but not limited to, an engine (internal combustion, gas, diesel, gaseous fuel, natural gas, propane, etc.), may be of any size, with any number of cylinders, and in any configuration (“V,” in-line, radial, etc.). The chassis 102 also supports various drive system components. These drive system components are capable of driving a set of drive wheels 108 to propel the machine 100. A set of idle wheels 110 can steer such that the machine 100 may move in any direction.

In the illustrated embodiments, the power source 107 may produce an output torque at an output shaft 109. The output shaft 109 of the power source 107 may be connected to a generator 111. In operation, the output shaft 109 of the power source 107 rotates a rotor (not shown) of the generator 111 to produce electrical power to drive motors 112 associated with the drive wheels 108. The motors 112 may be connected via intermediate assemblies or directly to drive wheels 108 of the machine 100. A person skilled in the art will understand that the generator 111 may produce electric power in the form of alternating current (AC) power. This electrical power is supplied to a rectifier and converted to direct current (DC) power. The rectified DC power may be converted again to an AC power by an inverter circuit. The inverter circuit may be capable of selectively adjusting the frequency and/or pulse-width of its output, such that the motors 112 may be operated at variable speeds.

The machine 100 may further include a pantograph assembly 114 mounted in front of the machine 100. Alternatively, machine 100 may include one or more pantograph assemblies connected with insulated pieces. The pantograph assembly 114 may be configured to supply electrical power from one or more overhead conductors 116 to the machine 100. Electrical power from the overhead conductor 116 may act as an auxiliary power source to assist in propulsion of the machine 100. The pantograph assembly 114 may shortcut the power source 107 and generator 111 thereby directly providing electrical power to the drive motors 112.

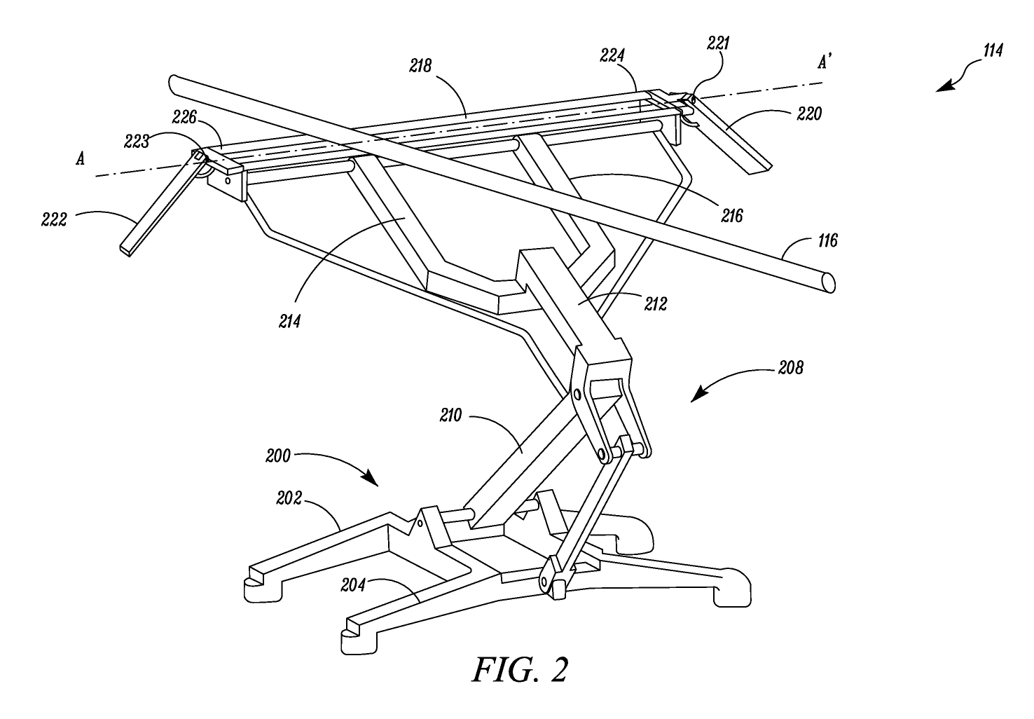

FIG. 2 illustrates the pantograph assembly 114, according to the present discloser. The pantograph assembly 114 includes a pantograph support 200. The pantograph support 200 may include a pair of legs 202 and 204. The pair of legs 202 and 204 may be mounted on the front of the machine 100, for example by using nut and bolts. Insulating members (not shown), such as rubber or plastic bellows, designed to keep the pantograph support 200 electrically insulated from the machine 100, may be provided at the pair of legs 202 and 204. Alternatively, based on the type of the machine and application the pantograph support 200 may have other types of mounting structure. Moreover, the pantograph assembly 114 may be mounted on the top of the machine 100.

An articulated assembly 208 is connected to the pantograph support 200. The articulated assembly 208 is configured to raise the pantograph assembly 114 and hold in contact with the overhead conductor 116. The articulated assembly 208 includes a first end 210 hingedly connected to the pantograph support 200 and a second end 212 hingedly connected to the first end 210. The hinged connection of the first end 210 with the second end 212, enables tilting of the first end 210 with respect to the second end 212. The second end 212 may include a first arm 214 and a second arm 216. Each of the first arm 214 and the second arm 216 extend from a common first end and form a fork-shaped structure. In the present disclosure, the first end 210 and the second end 212 may include a pneumatic or hydraulic piston-cylinder mechanism (not shown) to achieve the tilting movement of the first end 210 with respect to the second end 212.

The second end 212 may be connected to a collector rail 218 such that the collector rail 218 is supported on the second end 212 of the articulated assembly 208. As shown in FIG. 2 the collector rail 218 extends along a longitudinal axis AA′. In an alternative of the present disclosure, the collector rail 218 may include a pair of rails such as a first collector rail and a second collector rail. The collector rail 218 may include a metallic frame (not shown) and a carbon brushes supported by the metallic frame. It will be apparent to those skilled in the art that the carbon brushes are designed to provide an electrical contact with the overhead conductor 116.

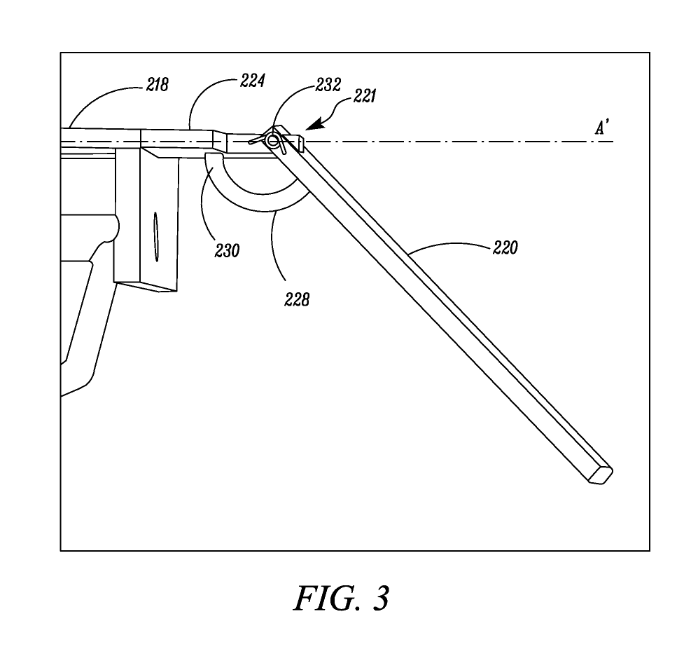

According to the present disclosure, an end horn 220 is connected to the collector rail 218. Specifically, the end horn 220 is connected to a first end portion 224 of the collector rail 218. The end horn 220 may be connected to the first end portion 224 of the collector rail 218 through a hinged connection 221, such that the end horn 220 is configured to be tilted with respect to the longitudinal axis A-A′ of the collector rail 218. Similarly, another end horn 222 is connected to a second end portion 226 of the collector rail 218 through another hinged connection 223. The another end horn 222 may be structurally similar to the end horn 220 and also configured to be tilted with respect to the longitudinal axis A-A′ of the collector rail 218. Moreover, the end horns 220 and 222 may be composed of a non-conducting material and configured to intercept the overhead conductor 116 and to guide it onto the collector rail 218. It will be apparent to a person skilled in the art that the end horns 220 and 222 are symmetrical with respect to the center line of the collector rail 218, and the FIG. 3 is described with reference to the end horn 220.

Referring now to FIG. 3, which illustrates a portion of the pantograph assembly 114 of FIG. 2. The end horn 220 may include a stopper 228 having a free end portion 230. The free end portion 230 of the stopper 228 may extend towards the collector rail 218. Moreover, in an embodiment, the hinge connection 221 may include a biasing member 232, such a torsion spring, to apply a biasing force at the end horn 220 in the tilted position relative to the collector rail 218. Thus in normal operating position, the free end portion 230 of the stopper 228 may abut the first end portion 224 of the collector rail 218 under the biasing force of the biasing member 232. It may be apparent to a person skilled in the art that in various other embodiments, the biasing member 232 may include any type of known elastic member to bias the end horns 220, 222 relative to the collector rail 218. In the present disclosure the end horns 220, 222 are tilted at about 45 degrees with respect to the longitudinal axis A-A′ of the collector rail 218. Further, in the present disclosure the end horns 220, 222 may be about 500 millimeter long.

### INDUSTRIAL APPLICABILITY

A machine, such as the machine 100 equipped with the pantograph assembly 114 may receive electrical power from an overhead conductor, such as the overhead conductor 116. During operation of the machine 100, the pantograph assembly 114 may shift from one overhead conductor to a different overhead conductor. The pantograph assembly 114 of the present disclosure may preclude the overhead conductor from entangling with the pantograph assembly 114 during a shift.

The machine 100 may operate in a predefined area, such as an open pit mine or mine haul road, which may be provided with a plurality of overhead conductors positioned along a travel path. During operation, the collector rail 218 of the pantograph assembly 114 may be required to contact an overhead conductor and subsequently contact another overhead conductor to receive electrical power. Accordingly, the pantograph assembly 114 may include end horns such as, the end horns 220, 222 hingedly connected to the first and the second end portions 224, 226 of the collector rail 218. The overhead conductor 116 may contact one of the end horns 220, 222, and slide thereon before contacting the collector rail 218. The tilted end horns 220, 222 ensure the overhead conductor 116 may be received over the pantograph assembly 114 from top side. In case the overhead conductor 116 approaches the end horns 220, 222 from underneath the pantograph assembly 114, the hinged connections 221, 223 of the end horns 220, 222 may enable the end horns 220, 222 to fold upward, thereby preventing the overhead conductor 116 from getting caught under the pantograph assembly 114. Further, under the biasing force of the biasing member 232 the end horns 220, 222 may fold downward and return to their normal operating position post the contact with the overhead conductor 116.

The stopper 228 may prevent the end horns 220, 222 from tilting beyond a predetermined angle. In the present disclosure, the stopper 228 prevents the end horns 220, 222 from tilting beyond 45 degree with respect to the longitudinal axis A-A′. Particularly, the free end portion 230 of the stopper 228, resting on the collector rail 218, provides a positive stop so that the biasing member 232 ensures a constant force acting on the end horns 220, 222 so as to maintain the tilting position with respect to the collector rail 218. Therefore, the overhead conductor 116 may be guided on and off of the pantograph assembly 114.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A pantograph assembly configured to transfer electrical power from an overhead conductor to a machine, the pantograph assembly comprising:
a pantograph support detachably connected to the machine;
an articulated assembly having a first end connected to the pantograph support;
a collector rail supported by a second end of the articulated assembly along a longitudinal axis; and,
an end horn connected to the collector rail, wherein the end horn is configured to be tilted with respect to the longitudinal axis of the collector rail.

2. The pantograph assembly of claim 1, wherein the end horn is tilted at about 45 degrees with respect to the longitudinal axis of the collector rail.

3. The pantograph assembly of claim 2, wherein the end horn includes a stopper extending from the end horn towards the collector rail.

4. The pantograph assembly of claim 3, wherein the stopper is configured to restrict tilting of the end horn with respect to the longitudinal axis of the collector rail.

5. The pantograph assembly of claim 3, wherein the stopper includes a free end portion configured to rest on the collector rail to restrict tilting of the end horn with respect to the longitudinal axis of the collector rail, beyond a predetermined tilt limit.

6. The pantograph assembly of claim 3, wherein the stopper is configured to restrict tilting of the end horn with respect to the longitudinal axis of the collector rail beyond about 45 degree.

7. The pantograph assembly of claim 1, wherein the end horn is about 500 millimeter long.

8. The pantograph assembly of claim 1, wherein the end horn includes a first end horn hingedly connected to a first end portion of the collector rail, and a second end horn hingedly connected to a second end portion of the connector rail.

9. The pantograph assembly of claim 1, wherein the end horn includes a biasing member to maintain the tilting position with respect to the collector rail.

10. A machine having a pantograph assembly configured to transfer electrical power from an overhead conductor to the machine for assisting propulsion of the machine, the machine comprising:
a pantograph support detachably connected to the machine;
an articulated assembly having a first end connected to the pantograph support;
a collector rail supported by a second end of the articulated assembly; and,
a end horn hingedly connected to the collector rail, the end horn is configured to be tilted with respect to a longitudinal axis of the collector rail.

11. The machine of claim 10, wherein the machine is an off highway haul truck.

12. The machine of claim 10, wherein the end horn is tilted at about 45 degree with respect to the longitudinal axis of the collector rail.

13. The machine of claim 10, wherein the end horn includes a stopper extending from the end horn towards the collector rail.

14. The machine of claim 13, wherein the stopper is configured to restrict tilting of the end horn with respect to the longitudinal axis of the collector rail.

15. The machine of claim 13, wherein the stopper includes a free end portion configured to rest on the collector rail to restrict tilting of the end horn with respect to the longitudinal axis of the collector rail, beyond a predetermined tilt limit.

16. The machine of claim 13, wherein the stopper is configured to restrict tilting of the end horn with respect to the longitudinal axis of the collector rail beyond about 45 degree.

17. The machine of claim 12, wherein the end horn is about 500 millimeter long.

18. The machine of claim 12, wherein the end horn includes a first end horn hingedly connected to a first end portion of the collector rail, and a second end horn hingedly connected to a second end portion of the connector rail.

19. The machine of claim 12, wherein the end horn includes a biasing member to maintain the tilting position with respect to the collector rail.

20. A machine having a pantograph assembly configured to transfer electrical power from an overhead conductor to the machine for assisting propulsion of the machine, the machine comprising:
a pantograph support detachably connected to the machine;
an articulated assembly having a first end connected to the pantograph support;
a collector rail supported by a second end of the articulated assembly; and,
a end horn hingedly connected to the collector rail, the end horn is configured to be tilted with respect to a longitudinal axis of the collector rail, the end horn having a stopper extending from the end horn towards the collector rail, wherein the stopper is configured to restrict tilting of the end horn with respect to the longitudinal axis of the collector rail beyond about 45 degree.
